(19) United States
(12) Patent Application Publication
(10) Pub. No.: US 2017/0206905 A1
(43) Pub. Date: Jul. 20, 2017

(54) METHOD, MEDIUM AND APPARATUS FOR ENCODING AND/OR DECODING SIGNAL BASED ON A PSYCHOACOUSTIC MODEL

(71) Applicant: SAMSUNG ELECTRONICS CO., LTD., Suwon-si (KR)

(72) Inventors: Eun-mi OH, Seongnam-si (KR); Ho-sang SUNG, Yongin-si (KR); Ki-hyun CHOO, Seoul (KR); Jung-hoe KIM, Seongnam-si (KR); Mi-young KIM, Hwaseong-si (KR)

(73) Assignee: SAMSUNG ELECTRONICS CO., LTD., Suwon-si (KR)

(21) Appl. No.: 15/477,643

(22) Filed: Apr. 3, 2017

Related U.S. Application Data
(63) Continuation of application No. 12/033,342, filed on Feb. 19, 2008.
(60) Provisional application No. 60/946,427, filed on Jun. 27, 2007.

(30) Foreign Application Priority Data
Oct. 23, 2007 (KR) 10-2007-0106737

(51) Int. Cl. G10L 19/02; G10L 19/20; G10L 19/16; G10L 19/025; G10L 19/008; G10L 19/24

(52) U.S. Cl. CPC G10L 19/02; G10L 19/008; G10L 19/24; G10L 19/167; G10L 19/025; G10L 19/20

(57) ABSTRACT

Provided are a method and apparatus for encoding or decoding an audio signal or a speech signal. In the encoding method, encoding is performed by performing domain transformation on a received signal in units of frequency bands by applying a psychoacoustic model, encoding the transformation result with respect to predetermined one or more frequency bands by using a high temporal resolution coding tool, and then quantizing the encoding result. In the decoding method, decoding is performed by inversely quantizing signals obtained by encoding in units of frequency bands, decoding one or more signals from among the inversely quantized signals, which are allocated to one or more frequency bands which have a predetermined domain resolution, determined by applying the psychoacoustic model, that is greater than a predetermined value, according to a predetermined method, and then inversely transforming either the inversely quantized or the one or more decoded signals.

### CROSS-REFERENCE TO RELATED APPLICATIONS

This is a continuation application of U.S. patent application Ser. No. 12/033,342, filed on Feb. 19, 2008, which claims the benefit of U.S. Provisional Patent Application No. 60/946,427, filed on Jun. 27, 2007 with the USPTO, and Korean Patent Application No. 10-2007-0106737, filed on Oct. 23, 2007, in the Korean Intellectual Property Office, the disclosures of which are incorporated herein in their entirety by reference.

### BACKGROUND OF THE INVENTION

1. Field of the Invention

The present invention relates to a method and apparatus for encoding and decoding an audio signal or a speech signal, and more particularly, to a method and apparatus capable of efficiently encoding and decoding an audio signal or a speech signal by using a small number of bits.

2. Description of the Related Art

Audio codecs and speech codecs have been independently developed to provide high-quality sound by using a small number of bits. Thus, an audio codec can encode and decode a signal having audio characteristics by using a small number of bits while guaranteeing high-quality sound. However, if the audio codec encodes or decodes a signal having speech characteristics by using the same number of bits used for encoding or decoding a signal having audio characteristics, sound quality deteriorates. Likewise, a speech codec can encode and decode a signal having speech characteristics by using a small number of bits while guaranteeing high-quality sound. However, if the speech codec encodes or decodes a signal having audio characteristics by using the same number of bits used for encoding and decoding a signal having speech characteristics, sound quality also deteriorates.

An additional coding tool, such as Temporal Noise Shaping (TNS) or window switching, has been used in order to solve this problem, i.e., to increase the efficiency of coding a speech signal by an audio codec, or visa versa. TNS is a technique of improving the sound quality of a transient signal or a pitched signal by increasing the temporal resolution thereof by performing prediction in the frequency domain. Also, if a short window is used, it is possible to alleviate pre-echo distortion which generally occurs when a speech signal is encoded using a small number of bits. Nevertheless, even if an audio codec encodes or decodes a speech signal by using TNS or window switching, sound deteriorates.

### SUMMARY OF THE INVENTION

One or more embodiments of the present invention provides a method and apparatus capable of encoding or decoding an audio signal or a speech signal by using a small number of bits, thereby guaranteeing high-quality sound.

According to an aspect of the present invention, there is provided a signal encoding method including determining predetermined domain resolution of each frequency band by applying a psychoacoustic model; performing domain transformation on a received signal in units of frequency bands according to the determined domain resolutions; encoding one or more signals, which have been allocated to one or more frequency bands, the determined domain resolution of which is greater than a predetermined value, according to a predetermined method; extracting a residual signal; and quantizing the signals obtained using domain transformation or the extracted residual signal.

According to another aspect of the present invention, there is provided a signal encoding method including determining temporal domain resolution of each frequency band by applying a psychoacoustic model; transforming a received signal into the temporal domain or the frequency domain in units of frequency bands according to the determined temporal resolutions; encoding one or more signals, which have been allocated to one or more frequency bands, the determined temporal resolution of which is greater than a predetermined value, according to a predetermined method; extracting a residual signal; and quantizing the signals obtained using domain transformation or the extracted residual signal.

According to another aspect of the present invention, there is provided a signal encoding method including determining temporal domain resolution of each frequency band by applying a psychoacoustic model; transforming a received signal to be represented in the temporal domain or the frequency domain according to the determined temporal resolution; encoding a signal, which has been allocated to a frequency band, the determined temporal resolution of which is greater than a predetermined value, according to a predetermined method; extracting a residual signal; and quantizing the domain-transformed signal or the extracted residual signal.

According to another aspect of the present invention, there is provided a computer readable medium having recorded thereon a computer program for executing a signal encoding method including determining predetermined domain resolution of each frequency band by applying a psychoacoustic model; performing domain transformation on a received signal in units of frequency bands according to the determined domain resolutions; encoding one or more signals, which have been allocated to one or more frequency bands, the determined domain resolution of which is greater than a predetermined value, according to a predetermined method; extracting a residual signal; and quantizing the signals obtained using domain transformation or the extracted residual signal.

According to another aspect of the present invention, there is provided a computer readable medium having recorded thereon a computer program for executing a signal encoding method including determining temporal domain resolution of each frequency band by applying a psychoacoustic model; transforming a received signal into the temporal domain or the frequency domain in units of frequency bands according to the determined temporal resolutions; encoding one or more signals, which have been allocated to one or more frequency bands, the determined temporal resolution of which is greater than a predetermined value, according to a predetermined method; extracting a residual signal; and quantizing the signals obtained using domain transformation or the extracted residual signal.

According to another aspect of the present invention, there is provided a computer readable medium having recorded thereon a computer program for executing a signal encoding method including determining temporal domain resolution of each frequency band by applying a psychoacoustic model; transforming a received signal to be represented in the temporal domain or the frequency domain according to the determined temporal resolution; encoding a signal, which has been allocated to a frequency band, the determined temporal resolution of which is greater than a predetermined value, according to a predetermined method; extracting a residual signal; and quantizing the domain-transformed signal or the extracted residual signal.

According to another aspect of the present invention, there is provided a signal encoding apparatus including a psychoacoustic model application unit that determines predetermined domain resolution of each frequency band by applying a psychoacoustic model; a transformation unit that performs domain transformation on a received signal in units of frequency bands according to the determined domain resolutions; a high resolution coding tool that encodes one or more signals allocated to one or more frequency bands, the determined domain resolution of which is greater than a predetermined value, according to a predetermined method and then extracts a residual signal, and a quantization unit that quantizes signals obtained by performing domain transformation or the extracted residual signal.

According to another aspect of the present invention, there is provided a signal encoding apparatus including a psychoacoustic model application unit that determines temporal resolution of each frequency band by applying a psychoacoustic model; a transformation unit that transforms a received signal into a temporal domain or a frequency domain in units of frequency bands according to the determined temporal resolutions; a high resolution coding tool that encodes one or more signals allocated to one or more frequency bands, the determined temporal resolution of which is greater than a predetermined value, according to a predetermined method and then extracts a residual signal, and a quantization unit that quantizes signals obtained by performing domain transformation or the extracted residual signal.

According to another aspect of the present invention, there is provided a signal encoding apparatus including a psychoacoustic model application unit that determines temporal resolution of each frequency band by applying a psychoacoustic model; a transformation unit that transforms a received signal to be represented in a temporal domain or a frequency domain according to the determined temporal resolution; a high resolution coding tool that encodes a signal allocated to a frequency band, the determined temporal resolution of which is greater than a predetermined value, according to a predetermined method and then extracts a residual signal, and a quantization unit that quantizes the domain-transformed signal or the extracted residual signal.

According to another aspect of the present invention, there is provided a signal decoding method including inversely quantizing signals obtained by encoding in units of frequency bands; decoding one or more signals allocated to one or more frequency bands whose predetermined domain resolution, which has been determined by applying a psychoacoustic model, is greater than a predetermined value according to a predetermined method, from among the inversely quantized signals; and inversely transforming the inversely quantized signals or the one or more decoded signals.

According to another aspect of the present invention, there is provided a signal decoding method including inversely quantizing signals obtained by encoding in a temporal domain or a frequency domain in units of frequency bands; decoding one or more signals allocated to one or more frequency bands whose temporal resolution, which has been determined by applying a psychoacoustic model, is greater than a predetermined value according to a predetermined method, from among the inversely quantized signals; and inversely transforming the inversely quantized signals or the one or more decoded signals.

According to another aspect of the present invention, there is provided a signal decoding method including inversely quantizing signals obtained by encoding in such a manner that a received signal can be represented in a temporal domain and a frequency domain; decoding a signal allocated to a frequency band whose temporal resolution, which has been determined by applying a psychoacoustic model, is greater than a predetermined value according to a predetermined method, from among the inversely quantized signals; and inversely transforming the inversely quantized signals or the decoded signal.

According to another aspect of the present invention, there is provided a computer readable medium having recorded thereon a computer program for executing a signal decoding method including inversely quantizing signals obtained by encoding in units of frequency bands; decoding one or more signals allocated to one or more frequency bands whose predetermined domain resolution, which has been determined by applying a psychoacoustic model, is greater than a predetermined value according to a predetermined method, from among the inversely quantized signals; and inversely transforming the inversely quantized signals or the one or more decoded signals.

According to another aspect of the present invention, there is provided a computer readable medium having recorded thereon a computer program for executing a signal decoding method including inversely quantizing signals obtained by encoding in a temporal domain or a frequency domain in units of frequency bands; decoding one or more signals allocated to one or more frequency bands whose temporal resolution, which has been determined by applying a psychoacoustic model, is greater than a predetermined value according to a predetermined method, from among the inversely quantized signals; and inversely transforming the inversely quantized signals or the one or more decoded signals.

According to another aspect of the present invention, there is provided a computer readable medium having recorded thereon a computer program for executing a signal decoding method including inversely quantizing signals obtained by encoding in such a manner that a received signal can be represented in a temporal domain and a frequency domain; decoding a signal allocated to a frequency band whose temporal resolution, which has been determined by applying a psychoacoustic model, is greater than a predetermined value according to a predetermined method, from among the inversely quantized signals; and inversely transforming the inversely quantized signals or the decoded signal.

According to another aspect of the present invention, there is provided a signal decoding apparatus including an inverse quantization unit that inversely quantizes signals obtained by encoding in units of frequency bands; a high resolution decoding tool that decodes one or more signals allocated to one or more frequency bands whose predetermined domain resolution, which has been determined by applying a psychoacoustic model, is greater than a predetermined value according to a predetermined method, from among the inversely quantized signals; and an inverse transformation unit that inversely transforms the inversely quantized signals or the decoded one or more signals.

According to another aspect of the present invention, there is provided a signal decoding apparatus including an inverse quantization unit that inversely quantizes signals obtained by encoding in a temporal domain or a frequency domain in units of frequency bands; a high resolution decoding tool that decodes one or more signals allocated to one or more frequency bands whose temporal resolution, which has been determined by applying a psychoacoustic model, is greater than a predetermined value according to a predetermined method, from among the inversely quantized signals; and an inverse transformation unit that inversely transforms the inversely quantized signals or the decoded one or more signals.

According to another aspect of the present invention, there is provided a signal decoding apparatus including an inverse quantization unit that inversely quantizes signals obtained by encoding a received signal to be represented in a temporal domain and a frequency domain; a high resolution decoding tool that decodes one or more signals allocated to one or more frequency bands whose temporal resolution, which has been determined by applying a psychoacoustic model, is greater than a predetermined value according to a predetermined method, from among the inversely quantized signals; and an inverse transformation unit that inversely transforms the inversely quantized signals or the decoded one or more signals.

According to another aspect of the present invention, there is provided a signal encoding method including performing domain transformation on a received signal in units of frequency bands; determining temporal and frequency resolutions of each frequency band by applying a psychoacoustic model; synthesizing one or more signals allocated to one or more frequency bands, the determined temporal resolution of which is greater than a predetermined value; transforming one or more signals allocated to one or more frequency bands, the determined frequency resolution of which is greater than a predetermined value according to a predetermined method, from among the domain-transformed signals; encoding the result of synthesization according to a predetermined method and extracting a residual signal, and quantizing either the residual signal or the one or more signals transformed according to the predetermined method.

According to another aspect of the present invention, there is provided a computer readable medium having recorded thereon a computer program for executing a signal encoding method including performing domain transformation on a received signal in units of frequency bands; determining temporal and frequency resolutions of each frequency band by applying a psychoacoustic model; synthesizing one or more signals allocated to one or more frequency bands, the determined temporal resolution of which is greater than a predetermined value; transforming one or more signals allocated to one or more frequency bands, the determined frequency resolution of which is greater than a predetermined value according to a predetermined method, from among the domain-transformed signals; encoding the result of synthesization according to a predetermined method and extracting a residual signal, and quantizing either the residual signal or the one or more signals transformed according to the predetermined method.

According to another aspect of the present invention, there is provided a signal encoding apparatus including a first transformation unit that performs domain transformation on a received signal in units of frequency bands; a psychoacoustic model application unit that determines temporal and frequency resolutions of each frequency band by applying a psychoacoustic model; a first inverse transformation unit that synthesizes one or more signals allocated to one or more frequency bands, the determined temporal resolution of which is greater than a predetermined value; a high resolution encoding tool that encodes one or more signals allocated to one or more frequency bands, the determined frequency resolution is greater than a predetermined value according to a predetermined value, from among signals obtained by domain transformation, and then extracts a residual signal; a second transformation unit that transforms the synthesizing result according to a predetermined method; and a quantization unit that quantizes either the residual signal or the one or more signals transformed according to the predetermined method.

According to another aspect of the present invention, there is provided a signal decoding method including inversely quantizing signals obtained by encoding in units of frequency bands; decoding one or more signals allocated to one or more frequency bands whose temporal resolution, which has been determined by applying a psychoacoustic model, is greater than a predetermined value according to a predetermined method, from among the inversely quantized signals; performing domain transformation on the decoded one or more signals in units of frequency bands; inversely transforming one or more signals allocated to one or more frequency bands whose frequency resolution, which has been determined by applying a psychoacoustic model, is greater than a predetermined value according to a predetermined method, from among the inversely quantized signals; and synthesizing the result of domain transformation or the inversely transformed one or more signals.

According to another aspect of the present invention, there is provided a computer readable medium having recorded thereon a computer program for executing a signal decoding method including inversely quantizing signals obtained by encoding in units of frequency bands; decoding one or more signals allocated to one or more frequency bands whose temporal resolution, which has been determined by applying a psychoacoustic model, is greater than a predetermined value according to a predetermined method, from among the inversely quantized signals; performing domain transformation on the decoded one or more signals in units of frequency bands; inversely transforming one or more signals allocated to one or more frequency bands whose frequency resolution, which has been determined by applying a psychoacoustic model, is greater than a predetermined value according to a predetermined method, from among the inversely quantized signals; and synthesizing the result of domain transformation or the inversely transformed one or more signals.

According to another aspect of the present invention, there is provided a signal decoding apparatus including an inverse quantization unit that inversely quantizes signals obtained by encoding in units of frequency bands; a high resolution decoding tool that decodes one or more signals allocated to one or more frequency bands whose temporal resolution, which has been determined by applying a psychoacoustic model, is greater than a predetermined value, according to a predetermined method, from among the inversely quantized signals; a first transformation unit that performs domain transformation on the one or more decoded signals in units of frequency bands, a second inverse transformation unit that inversely transforms one or more signals allocated to one or more frequency bands whose frequency resolution, which has been determined by applying a psychoacoustic model, is greater than a predetermined value according to a predetermined method, from among the inversely quantized signals; and a first inverse transformation unit that synthesizes the result of domain transformation or the inversely transformed one or more signals.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a signal encoding apparatus according to an embodiment of the present invention;

FIG. 2 is a block diagram of a signal decoding apparatus according to an embodiment of the present invention;

FIG. 3 is a block diagram of a signal encoding apparatus according to another embodiment of the present invention;

FIG. 4 is a block diagram of a signal decoding apparatus according to another embodiment of the present invention;

FIG. 5 is a flowchart illustrating a signal encoding method according to an embodiment of the present invention;

FIG. 6 is a flowchart illustrating a signal decoding method according to an embodiment of the present invention;

FIG. 7 is a flowchart illustrating a signal encoding method according to another embodiment of the present invention; and

FIG. 8 is a flowchart illustrating a signal decoding method according to another embodiment of the present invention.

### DETAILED DESCRIPTION OF THE PREFERRED EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are merely described below, by referring to the figures, to explain aspects of the present invention.

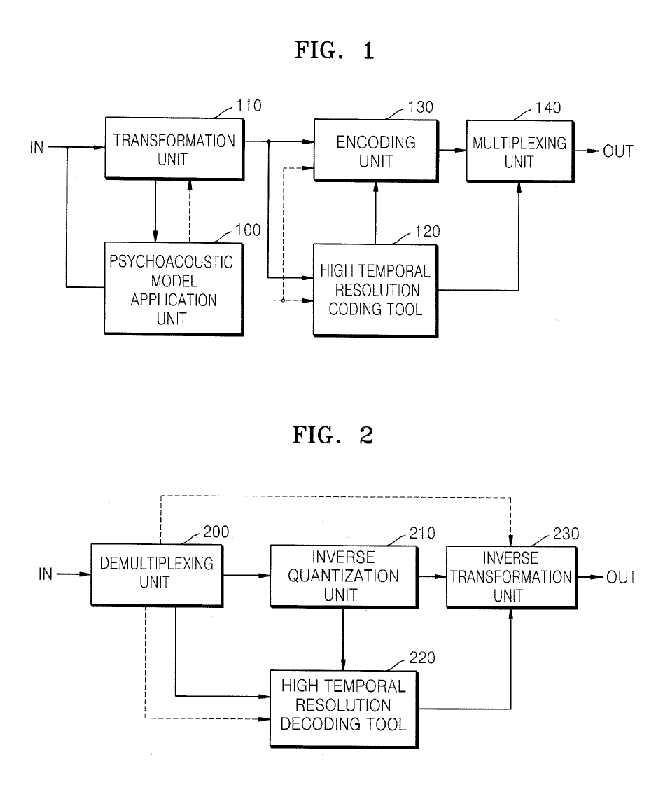

FIG. 1 is a block diagram of a signal encoding apparatus according to an embodiment of the present invention. The signal encoding apparatus includes a psychoacoustic model application unit 100, a transformation unit 110, a high temporal resolution coding tool 120, an encoding unit 130, and a multiplexing unit 140.

The psychoacoustic model application unit 100 applies a psychoacoustic model to a signal received via an input terminal IN in order to determine a temporal resolution and frequency resolution for each of a plurality of frequency bands.

According to an embodiment of the present invention, the psychoacoustic model application unit 100 extracts predetermined parameters of a speech signal or an audio signal to which the psychoacoustic model is to be applied, and determines the temporal and frequency resolutions by using the extracted parameters.

Also, the psychoacoustic model application unit 100 determines the degree of quantization, i.e., a quantization step size, of a signal allocated to each frequency band by applying the psychoacoustic model.

The transformation unit 110 performs domain transformation in order to represent the received signal in both the time domain and the frequency domain. In order to represent the received signal in both the time domain and the frequency domain, the signal can be divided and represented in the time domain or the frequency domain in units of frequency bands. An example of transformation performed by the transformation unit 110 includes frequency varying-modulated lapped transformation (FV-MLT). Also, the transformation performed by the transformation unit 110 may be a combination of using a filterbank for subband filtering, such as extended lapped transformation (ELT), which is performed by a quadrature mirror filterbank (QMF), and a transformation method, such as modulated lapped transformation (MLT), modified discrete cosine transformation (MDCT), and modified discrete sine transformation (MOST).

Here, the transformation unit 110 performs transformation according to the temporal and frequency resolutions determined by the psychoacoustic model application unit 100.

The high temporal resolution coding tool 120 encodes one or more signals allocated to one or more frequency bands whose temporal resolution, which was determined by the psychoacoustic model application unit 100, is greater than a predetermined value according to a predetermined method, from among signals transformed by the transformation unit 110 in units of frequency bands. Then the high temporal resolution coding tool 120 extracts one or more residual signals that remain after the signal encoding.

Examples of the predetermined method include linear prediction, long-term prediction, and pitch prediction. In an embodiment of the present invention, the high temporal resolution coding tool 120 performs linear prediction on one or more signals allocated to one or more frequency domains whose temporal resolution, which was determined by the psychoacoustic model application unit 100, is greater than a predetermined value in order to encode a linear prediction coefficient, performs long-term prediction on a first residual signal remaining after the linear prediction in order to encode a gain of the long-term prediction, performs pitch prediction on a second residual signal remaining after the long-term prediction in order to encode a gain of the pitch prediction, and then extracts a third residual signal remaining after the pitch prediction. That is, the high temporal resolution coding tool 120 encodes the linear prediction coefficient, the gain of the long-term prediction, and the gain of the pitch prediction, and extracts the third residual signal.

The quantization unit 130 quantizes the one or more signals allocated to the one or more frequency bands whose temporal resolution, which was determined by the psychoacoustic model application unit 100, is greater than the predetermined value, from among the signals transformed by the transformation unit 110 in units of frequency bands, and the one or more residual signals extracted by the high temporal resolution coding tool 120. Here, the quantization unit 130 can perform signal quantization according to the degree of quantization determined by the psychoacoustic model application unit 100, and in particular, can quantize a signal generated via the high temporal resolution coding tool 120 by using a combination of pulses, as done when using the Algebraic Code Excited Linear Predictor (ACELP) speech encoding algorithm. The quantized information may be losslessly compressed in order to reduce the amount thereof.

The multiplexing unit 140 multiplexes the temporal and frequency resolutions determined by the psychoacoustic model application unit 100, the encoding result received from the high temporal resolution coding tool 120, and the quantizing result received from the quantization unit 130 into a bitstream and then outputs the bitstream via an output terminal OUT.

FIG. 2 is a block diagram of a signal decoding apparatus according to an embodiment of the present invention. The signal decoding apparatus includes a demultiplexing unit 200, an inverse quantization unit 210, a high temporal resolution decoding tool 220, and an inverse transformation unit 230.

The demultiplexing unit 200 receives a bitstream from an encoding apparatus (not shown) via an input terminal IN, and demultiplexes the bitstream. The demultiplexing unit 200 demultiplexes the bitstream into temporal and frequency resolutions of each of a plurality of frequency bands that the encoding apparatus has determined by applying the psychoacoustic model, the result of encoding with respect to one or more predetermined frequency bands according to a predetermined method, and the result of quantization performed by the encoding apparatus.

The inverse quantization unit 210 inversely quantizes the quantizing result received from the demultiplexing unit 200. The quantization unit 130 of the signal encoding apparatus illustrated in FIG. 1 quantizes a signal allocated to each of frequency bands by determining the degree of quantization, i.e., the quantization step size, of the signal by applying the psychoacoustic model, and the inverse quantization unit 210 of the signal decoding apparatus illustrated in FIG. 2 inversely quantizes the quantized signal.

The high temporal resolution decoding tool 220 decodes one or more signals allocated to one or more frequency bands whose temporal resolution, which was determined by the encoding apparatus, is greater than a predetermined value according to a predetermined method, from among the signals being inversely quantized by the inverse quantization unit 210. Examples of the predetermined method include linear prediction synthesis, long-term prediction synthesis, and pitch prediction synthesis.

More specifically, the high temporal resolution decoding tool 220 synthesizes residual signals that are the result of inverse quantization performed by the inverse quantization unit 210 with the result of decoding the encoding result received from the demultiplexing unit 200. For example, the high temporal resolution decoding tool 220 synthesizes the inversely quantized residual signals with the result of decoding a long-term prediction gain, and then synthesizes the synthesization result with a linear prediction coefficient.

Here, the temporal resolution for each of the frequency bands is determined by the encoding apparatus applying the psychoacoustic model to a received signal. In an embodiment of the present invention, predetermined parameters of a speech signal or an audio signal to which the psychoacoustic model is to be applied are extracted, and the temporal and frequency resolutions of each frequency band are determined by using the extracted parameters.

Also, the high temporal resolution decoding tool 220 performs decoding by using the temporal or frequency resolution of each of the frequency bands.

The inverse transformation unit 230 inversely transforms one or more signals allocated to one or more frequency bands whose temporal resolution is less than a predetermined value from among the result of the inverse quantization, which is received from the inverse quantization unit 210, and the one or more decoded signals, synthesizes the inversely transformed signals together in order to restore the original signal, and then outputs the original signal via an output terminal OUT. Here, the inverse transformation unit 230 synthesizes the results of dividing a received signal in units of frequency bands, and inversely transforms the synthesizing result into a single signal represented in the temporal domain.

In an embodiment of the present invention, the inverse transformation performed by the inverse transformation unit 230 is the inverse of the transformation performed by the transformation unit 110 illustrated in FIG. 1, such as inverse FV-MLT. Also, the inverse transformation performed by the inverse transformation unit 230 may be a combination of using a filterbank for subband filtering, such as ELT, which is performed by the QMF, and an inverse transformation method, such as inverse MLT, inverse MDCT, and inverse MOST.

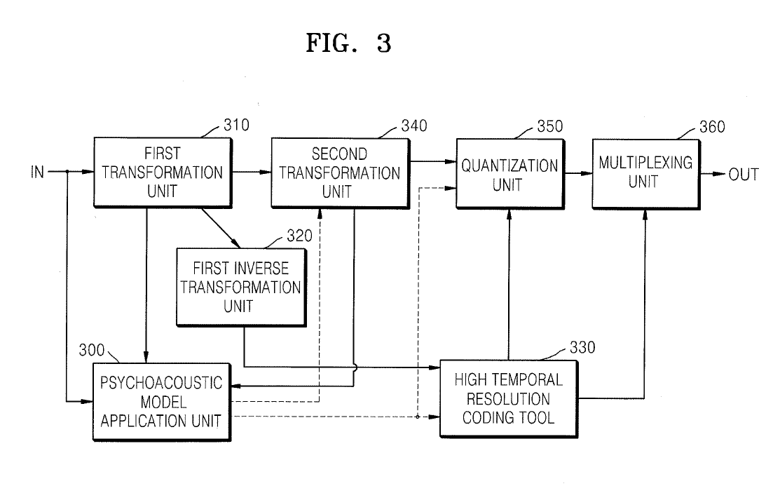

FIG. 3 is a block diagram of a signal encoding apparatus according to another embodiment of the present invention. The signal encoding apparatus includes a psychoacoustic model application unit 300, a first transformation unit 310, a first inverse transformation unit 320, a high temporal resolution coding tool 330, a second transformation unit 340, a quantization unit 350, and a multiplexing unit 360.

The psychoacoustic model application unit 300 determines the temporal and frequency resolutions of each of frequency bands by applying the psychoacoustic model to a signal received via an input terminal IN. Then the psychoacoustic model application unit 300 encodes the determined temporal and frequency resolutions.

In an embodiment of the present invention, the psychoacoustic model application unit 300 extracts predetermined parameters of a speech signal or an audio signal to which the psychoacoustic model is to be applied, and determines the temporal and frequency resolutions of the speech signal or the audio signal by using the extracted parameters.

Also, the psychoacoustic model application unit 300 determines the degree of quantization, i.e., the quantization step size, of a signal allocated to each of a plurality of frequency bands by applying the psychoacoustic model.

The first transformation unit 310 transforms the signal, which is received via the input terminal IN, in units of frequency bands by using filterbank analysis enabling subband filtering, such as ELT, which is performed by the QMF.

The first inverse transformation unit 320 inversely transforms one or more signals allocated to one or more frequency bands whose temporal resolution, which was determined by the psychoacoustic model application unit 300, is greater than a predetermined value, from among signals transformed by the transformation unit 310 in units of frequency bands.

A filterbank used by the first transformation unit 310 can process all of the frequency bands but a filterbank used by the first inverse transformation unit 320 can process only some of the frequency bands.

The high temporal resolution coding tool 330 encodes the one or more signals that have been inversely transformed by the first inverse transformation unit 320, according to a predetermined method. Then the high temporal resolution coding tool 330 extracts residual signals remaining after the signal encoding.

Examples of the predetermined method include linear prediction, long-term prediction, and pitch prediction. For example, the high temporal resolution coding tool 330 encodes a linear prediction coefficient by performing linear prediction on the one or more signals being inversely transformed by the first inverse transformation unit 320, encodes a gain of the linear prediction by performing long-term prediction on a first residual signal remaining after the linear prediction, encodes a gain of the long-term prediction by performing pitch prediction on a second residual signal remaining after the long-term prediction, and then extracts a third residual signal remaining after the pitch prediction. Thus, the high temporal resolution coding tool 330 encodes the linear prediction coefficient, the gain of the long-term prediction and the gain of the long-term prediction, and extracts the third residual signal.

The second transformation unit 340 transforms one or more signals allocated to one or more frequency bands requiring a higher frequency resolution, such as one or more signals allocated to one or more frequency bands whose frequency resolution has been determined to be greater than a predetermined value by the psychoacoustic model application unit 300, according to a predetermined transform method, from among the signals transformed by the transformation unit 310 in units of frequency bands. Here, examples of the transformation include MLT, MDCT, and MOST.

The quantization unit 350 quantizes the residual signals extracted by the high temporal resolution coding tool 330 and the one or more signals transformed by the second transformation unit 340. The quantization unit 350 can quantize the above signals according to the degree of quantization determined by the psychoacoustic model application unit 300, and in particular, can quantize a signal generated via the high temporal resolution coding tool 330 by using a combination of pulses as done when using the ACELP speech encoding algorithm. The quantized information may be losslessly compressed in order to reduce the amount thereof.

The multiplexing unit 360 multiplexes the temporal and frequency resolutions encoded by the psychoacoustic model application unit 300, the encoding result received from the high temporal resolution coding tool 330, and the quantizing result received from the quantization unit 350 into a bitstream, and outputs the bitstream via an output terminal OUT.

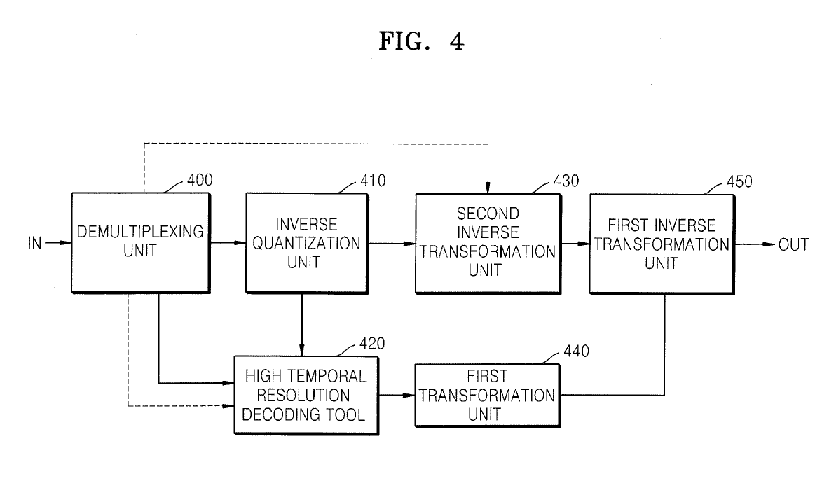

FIG. 4 is a block diagram of a signal decoding apparatus according to another embodiment of the present invention. The signal decoding apparatus includes a demultiplexing unit 400, an inverse quantization unit 410, a high temporal resolution decoding tool 420, a second inverse transformation unit 430, a first transformation unit 440, and a first inverse transformation unit 450.

The demultiplexing unit 400 receives a bitstream from an encoding apparatus (not shown) via an input terminal IN, and demultiplexes the bitstream. In detail, the demultiplexing unit 400 demultiplexes the bitstream into temporal and frequency resolutions encoded by the encoding apparatus, the result of encoding with respect to one or more predetermined frequency bands according to a predetermined method, and the result of quantization performed by the encoding apparatus.

The inverse quantization unit 410 inversely quantizes the result of quantization received from the demultiplexing unit 400. The quantization unit 350 of the signal encoding apparatus illustrated in FIG. 3 quantizes a signal allocated to each frequency band by determining the degree of quantization, i.e., the quantization step size, of the signal by applying the psychoacoustic model, and the inverse quantization unit 410 of the signal decoding apparatus illustrated in FIG. 4 inversely quantizes the quantized signals by performing the inverse of the quantization.

The high temporal resolution decoding tool 420 decodes one or more signals allocated to one or more frequency bands whose temporal resolution, which was determined by the encoding apparatus, is greater than a predetermined value according to a predetermined method, from among the signals being inversely quantized by the inverse quantization unit 410. Examples of the predetermined method are linear prediction synthesis, long-term prediction synthesis, and pitch prediction synthesis.

More specifically, the high temporal resolution decoding tool 420 synthesizes residual signals that are the result of inverse quantization performed by the inverse quantization unit 410 with the result of decoding the encoding result with respect to one or more frequency bands according to the predetermined method, which was received from the demultiplexing unit 400. For example, the high temporal resolution decoding tool 420 synthesizes residual signals that have been inversely quantized by the inverse quantization unit 410 with the result of decoding a gain of long-term prediction, and then synthesizes the synthesization result with the result of decoding a linear prediction coefficient.

The temporal resolution of each frequency band is determined by the encoding apparatus applying the psychoacoustic model to a received signal. In an embodiment of the present invention, the encoding apparatus extracts predetermined parameters of a speech signal or an audio signal to which the psychoacoustic model is to be applied, and determines the temporal and frequency resolutions of each frequency band by using the extracted parameters.

Also, the high temporal resolution decoding tool 420 performs decoding by using the temporal or frequency resolution of each frequency band.

The second inverse transformation unit 430 inversely transforms one or more signals allocated to one or more frequency bands requiring a higher frequency resolution, such as one or more signals allocated to one or more frequency bands whose frequency resolution has been determined to be greater than a predetermined value by the encoding apparatus, according to a predetermined inverse transformation method, from among the signals being inversely quantized by the inverse quantization unit 410. Here, examples of the inverse transformation are MLT, MDCT, and MOST.

The first transformation unit 440 transforms the one or more signals decoded by the high temporal resolution decoding tool 420 in units of frequency bands by using filterbank analysis enabling subband filtering, such as ELT, which is performed by the QMF, where the transformation performed by the first transformation unit 440 is identical to the transformation performed by the first transformation unit 310 of FIG. 3 and the inverse of the inverse transformation performed by the first inverse transformation unit 320 of FIG. 3.

Filterbanks used by the first transformation unit 310 and the first inverse transformation unit 450 can process the whole frequency bands but those used by the first inverse transformation unit 320 and the first transformation unit 440 can process only some of the whole frequency bands.

The first inverse transformation unit 450 inversely transforms the one or more signals being inversely transformed by the second inverse transformation unit 430 and the one or more signals being transformed by the first transformation unit 440 by using filterbank synthesis in order to restore the original signal, and then outputs the original signal via an output terminal OUT, where the inverse transformation performed by the first inverse transformation unit 450 is identical to the inverse transformation performed by the first inverse transformation unit 320 and the inverse of the transformation performed by the first transformation unit 310 of FIG. 3.

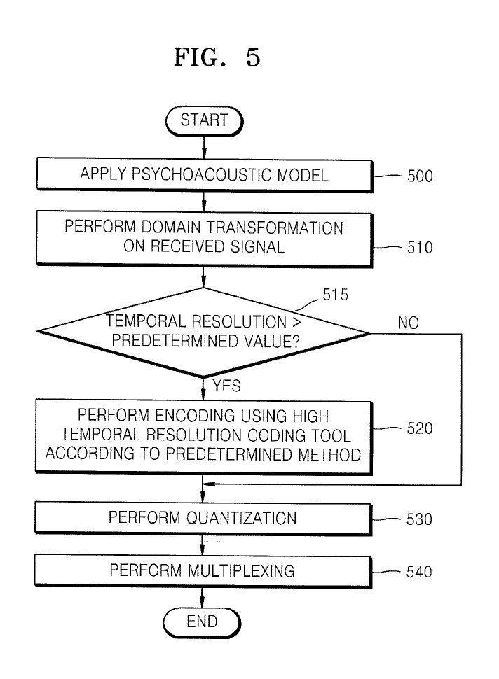

FIG. 5 is a flowchart illustrating a signal encoding method according to an embodiment of the present invention. First, the temporal and frequency resolutions of each frequency band are determined by applying the psychoacoustic model to a received signal (operation 500).

In an embodiment of the present invention, in operation 500, predetermined parameters of a speech signal or an audio signal to which the psychoacoustic model is to be applied are extracted, and the temporal and frequency resolutions of each frequency band are determined by using the extracted parameters.

Also, in operation 500, the degree of quantization, i.e., the quantization step size, of a signal allocated to each frequency band is determined by applying the psychoacoustic model.

After operation 500, domain transformation is performed on the received signal in order to represent the signal both in the time domain and the frequency domain (operation 510). In this case, operation 510 may be performed by dividing the signal in units of frequency bands and representing the signals in the time domain or the frequency domain. The transformation method performed in operation 510 may be FV-MLT. Also, operation 510 may be performed using a combination of using a filterbank enabling subband filtering, such as ELT, which is performed by the QMF, and a transformation method, such as MLT, MDCT, and MOST.

In operation 510, transformation is performed according to the temporal and frequency resolutions determined in operation 500.

Next, it is determined whether the signals transformed in units of frequency bands in operation 510 are allocated to one or more frequency bands whose temporal resolution has been determined in operation 500 to be greater than a predetermined value (operation 515)

Then, one or more signals from among the transformed signals, which are determined as being allocated to one or more frequency bands whose temporal resolution is greater than the predetermined value in operation 515, are encoded using a high temporal resolution coding tool according to a predetermined method, and then one or more residual signals, which remain after the signal encoding, are extracted (operation 520).

Examples of the predetermined method include linear prediction, long-term prediction, and pitch prediction. In an embodiment of the present invention, in operation 520, linear prediction is performed on one or more signals allocated to one or more frequency bands whose temporal resolution has been determined in operation 500 to be greater than a predetermined value in order to encode a linear prediction coefficient, long-term prediction is performed on a first residual signal remaining after the linear prediction in order to encode a gain of the long-term prediction, pitch prediction is performed on a second residual signal remaining after the long-term prediction in order to encode a gain of the pitch prediction, and then a third residual signal, which remains after the pitch prediction, is extracted. Accordingly, in operation 520, a linear prediction coefficient, the gain of the long-term prediction, and the gain of the pitch prediction are encoded, and the third residual signal is extracted.

Next, one or more signals from among the signals transformed in operation 510, which are allocated to one or more frequency bands whose temporal resolution is determined in operation 500 to be less than the predetermined value, and the one or more residual signals extracted in operation 520 are quantized (operation 530). In operation 530, the above signals can be quantized according to the degree of quantization determined in operation 500, and in particular, a signal generated via the high temporal resolution coding tool can be quantized by using a combination of pulses as done when using the ACELP speech encoding algorithm. The quantized information may be losslessly compressed in order to reduce the amount thereof.

Next, the one or more signals encoded in operation 520 and the signals quantized in operation 530 are multiplexed into a bitstream (operation 540).

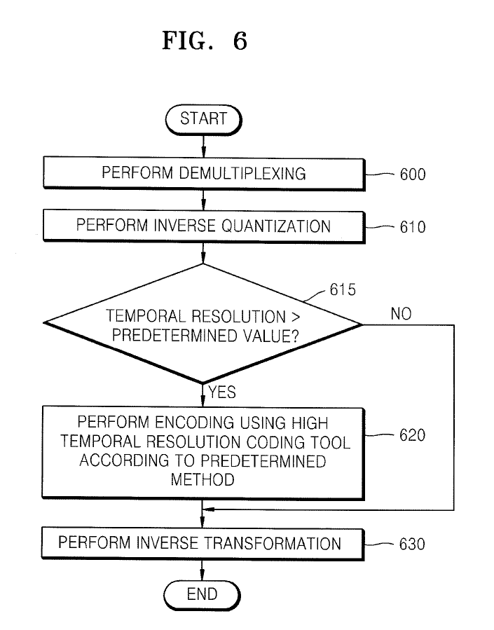

FIG. 6 is a flowchart illustrating a signal decoding method according to an embodiment of the present invention. First, a bitstream is received from an encoding apparatus and then is demultiplexed (operation 600). In operation 600, the bitstream is demultiplexed into the result of encoding with respect to predetermined one or more frequency bands according to a predetermined method and the result of quantization performed by the encoding apparatus.

Next, the result of quantizing obtained in operation 600 is inversely quantized (operation 610). The encoding apparatus quantizes one or more signals allocated to one or more frequency bands by determining the degree of quantization, i.e., the quantization step size, of the signals by applying the psychoacoustic model, and the one or more signals quantized according to the degree of quantization are inversely quantized, by performing the inverse of the quantization operation 530 illustrated in FIG. 5, in operation 610.

Next, it is determined whether one or more signals from among the one or more signals being inversely quantized in operation 610 are allocated to one or more frequency bands whose temporal resolution is determined by the encoding apparatus to be greater than a predetermined value (operation 615).

Next, the one or more signals determined as being allocated to one or more frequency bands whose temporal resolution is greater than the predetermined value in operation 615, are decoded using a high temporal resolution decoding tool (operation 620). Examples of the predetermined method include linear prediction synthesis, long-term prediction synthesis, and pitch prediction synthesis.

More specifically, in operation 620, one or more residual signals that are the result of the inverse quantization performed in operation 610 are synthesized with the result of decoding the result of encoding with respect to the predetermined one or more frequency bands according to the predetermined method, which has been obtained in operation 600. For example, in operation 620, the one or more residual signals being inversely quantized in operation 610 are synthesized with the result of decoding a gain of long-term prediction, and the synthesization result is synthesized with the result of decoding a linear prediction coefficient.

The temporal resolution of each frequency band is determined by the encoding apparatus applying the psychoacoustic model to a received signal. In an embodiment of the present invention, the encoding apparatus extracts predetermined parameters of a speech signal or an audio signal to which the psychoacoustic model is to be applied, and determine the temporal and frequency resolutions of each frequency band by using the extracted parameters.

Next, one or more signals that have been determined as being allocated to one or more frequency bands whose temporal resolution is less than the predetermined value in operation 615, and the one or more signals decoded in operation 620 are inversely transformed in order to restore the original signal (operation 630). In operation 630, the results of dividing the signal in units of frequency bands are synthesized together so as to be inversely transformed into a single signal represented in the temporal domain.

Here, the inverse transformation operation 630 is the inverse of the transformation operation 510 of FIG. 5, and may be inverse FV-MLT. Alternatively, the inverse transformation operation 630 may be a combination of use of a filterbank for subband filtering, such as ELT, which is performed using the QMF, and an inverse transformation method, such as inverse MLT, inverse MDCT, and inverse MOST.

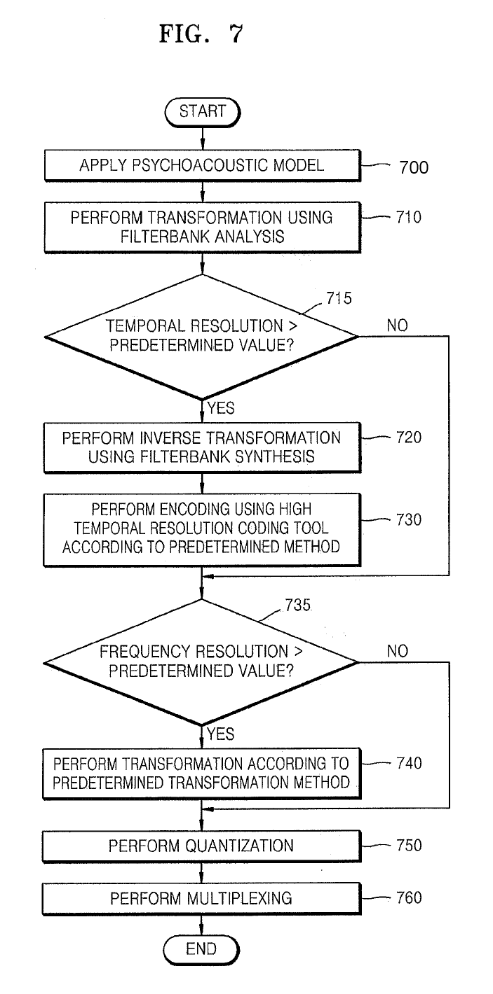

FIG. 7 is a flowchart illustrating a signal encoding method according to another embodiment of the present invention. First, the temporal and frequency resolutions of each frequency band are determined by applying the psychoacoustic model to a received signal (operation 700). Also, in operation 700, the determined temporal and frequency resolutions of each frequency band is encoded.

In an embodiment of the present invention, in operation 700, predetermined parameters of a speech signal or an audio signal to which the psychoacoustic model is to be applied are extracted, and the temporal and frequency resolutions of each frequency band are determined by using the extracted parameters.

Also, in operation 700, the degree of quantization, i.e., quantization step size, of a signal allocated to each frequency band is determined by applying the psychoacoustic model.

Next, a received signal is transformed in units of frequency bands by using filterbank analysis enabling subband filtering, such as the ELT, which is performed by the QMF (operation 710).

Next, it is determined whether signals obtained by performing the transformation operation 710 are allocated to one or more frequency bands whose temporal resolution is determined in operation 700 to be greater than a predetermined value (operation 715).

Next, one or more signals that have been determined as being allocated to one or more frequency bands whose temporal resolution is greater than the predetermined value in operation 715 are inversely transformed by filterbank synthesis (operation 720).

A filterbank used in operation 710 can process all of the frequency bands but a filterbank used in operation 720 can process only some of the frequency bands.

The one or more signals being inversely transformed in operation 720 are encoded using a high temporal resolution coding tool, and residual signals, which remain after the signal encoding, are extracted (operation 730).

Examples of the predetermined method include linear prediction, long-term prediction, and pitch prediction. For example, in operation 730, linear prediction is performed on the one or more signals being inversely transformed in operation 720 in order to encode a linear prediction coefficient, long-term prediction is performed on a first residual signal remaining after the linear prediction in order to encode a gain of the long-term prediction, pitch prediction is performed on a second residual signal remaining after the long-term prediction in order to encode a gain of the pitch prediction, and then, a third residual signal, which remains after the pitch prediction, is extracted. Thus, in operation 730, a linear prediction coefficient, the gain of the long-term prediction, and the gain of the pitch prediction are encoded, and the third residual signal is extracted.

Next, it is determined whether the signals obtained by performing transformation in operation 710 are signals allocated to one or more frequency bands requiring a higher frequency resolution, such as one or more signals allocated to one or more frequency bands whose frequency resolution has been determined to be greater than a predetermined value in operation 700 (operation 735).

Then, the one or more signals allocated to the one or more frequency bands whose frequency resolution has been determined to be greater than a predetermined value in operation 735, are transformed according to a predetermined transformation method (operation 740). Examples of the predetermined transformation method are MLT, MDCT, and MOST.

Next, the residual signals extracted in operation 730 and the one or more signals transformed in operation 740 are quantized (operation 750). In operation 750, the above signals can be quantized according to the degree of quantization determined in operation 700, and particularly, a signal generated via the high temporal resolution coding tool can be quantized by using a combination of pulses, as done when using the ACELP speech encoding algorithm. The quantized information can be losslessly compressed in order to reduce the amount thereof.

Thereafter, the temporal and frequency resolutions encoded in operation 700, the signals encoded in operation 730, and the signals quantized in operation 750 are multiplexed into a bitstream (operation 760).

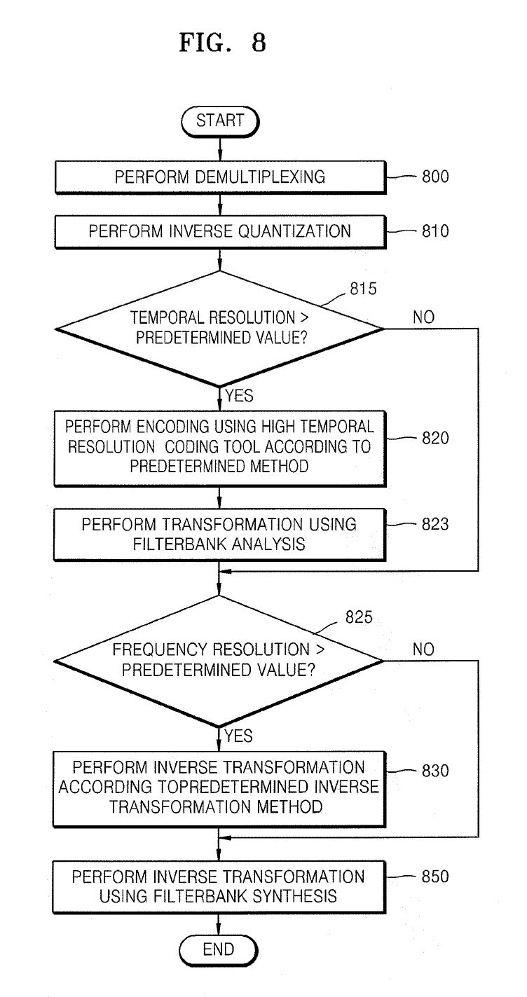

FIG. 8 is a flowchart illustrating a signal decoding method according to another embodiment of the present invention. First, a bitstream is received from an encoding apparatus and then is demultiplexed (operation 800). In operation 800, the bitstream is demultiplexed into temporal and frequency resolutions encoded by the encoding apparatus, the result of encoding with one or more predetermined frequency bands according to a predetermined method, and the result of quantization performed by the encoding apparatus.

Next, the result of quantization obtained in operation 800 is inversely quantized(operation 810). The encoding apparatus determines the degree of quantization, i.e., the quantization step size, of one or more signals allocated to one or more frequency bands by applying the psychoacoustic model and then quantizes the signals according to the degree of quantization, and the one or more quantized signals are inversely quantized by performing the inverse of the quantization operation 750 of FIG. 3.

Next, it is determined whether the one or more signals being inversely quantized in operation 810 are allocated to one or more frequency bands whose temporal resolution is determined by the encoding apparatus to be greater than a predetermined value (operation 815).

Next, the one or more signals that have been determined as being allocated to the one or more frequency bands whose temporal resolution is greater than the predetermined value in operation 815, are decoded using a high temporal resolution decoding tool according to a predetermined method (operation 820). Examples of the predetermined method include linear prediction synthesis, long-term prediction, and pitch prediction synthesis.

More specifically, in operation 820, residual signals that are the result of the inversely quantization operation 810 are synthesized with the result of decoding the result of encoding with respect to one or more predetermined frequency bands according to the predetermined method, which was obtained in operation 800. For example, in operation 820, the residual signals being inversely quantized in operation 810 are synthesized with the result of decoding a gain of long-term prediction, and then the synthesizing result is synthesized with a linear prediction coefficient.

The temporal resolution of each frequency band is determined by the encoding apparatus applying the psychoacoustic model to a received signal. In an embodiment of the present invention, the encoding apparatus extracts predetermined parameters of a speech signal or an audio signal to which the psychoacoustic model is to be applied, and the temporal and frequency resolutions of each frequency band are determined by using the extracted parameters.

Next, the one or more signals decoded in operation 820 are transformed in units of frequency bands by using filterbank analysis enabling subband filtering, such as ELT, which is performed by the QMF, where the transformation operation 820 is identical to the transformation operation 710 of FIG. 7 and the inverse of the inverse transformation operation 720 of FIG. 7 (operation 823).

The filterbank used in operation 710 and operation 850 can process all of the frequency bands but the filterbank used in operation 720 and operation 840 can process only some of the frequency bands.

Next, it is determined whether the one or more signals being inversely quantized in operation 810 are signals being allocated to one or more frequency bands requiring a higher frequency resolution, such as one or more signals allocated to one or more frequency bands whose frequency resolution has been determined to be greater than a predetermined value by the encoding apparatus (operation 825).

Next, one or more signals that have been determined as being allocated to one or more frequency bands whose frequency resolution is greater than the predetermined value in operation 825, are inversely transformed according to a predetermined transformation method which is the inverse of the transformation operation 740 of FIG. 7 (operation 830). Examples of the inverse transformation include inverse MLT, inverse MDCT, and inverse MOST.

Thereafter, the one or more signals being transformed in operation 823 and the one or more signals being inversely transformed in operation 830 are inversely transformed using filterbank synthesis in order to restore the original signal, where the inverse transformation operation 835 is identical to the inverse transformation operation 720 and the inverse of the transformation operation 710 (operation 850).

In a signal encoding method and apparatus according to the present invention, encoding is performed by performing domain transformation on a received signal in units of frequency bands by applying a psychoacoustic model, encoding the transformation result with respect to one or more predetermined frequency bands by using a high temporal resolution coding tool, and then quantizing the encoding result. In a signal decoding method and apparatus according to the present invention, decoding is performed by inversely quantizing signals obtained by encoding in units of frequency bands, decoding one or more signals from among the inversely quantized signals, which are allocated to one or more frequency bands whose predetermined domain resolution that has been determined by applying the psychoacoustic model is greater than a predetermined value, according to a predetermined method, and then inversely transforming either the inversely transformed signals or a restored signal.

Accordingly, even if an encoding apparatus encodes both an audio signal and a speech signal by using a small number of bits, a decoding apparatus can guarantee high-quality signal restoration, thereby increasing the efficiency of encoding or decoding.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CO-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Any narrowing or broadening of functionality or capability of an aspect in one embodiment should not considered as a respective broadening or narrowing of similar features in a different embodiment, i.e., descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed:

1. A method of encoding a signal, the method comprising:
determining whether a linear prediction based coding is performed or a psychoacoustic based coding is performed on the signal, in a switching structure between a plurality of coding domains including a frequency domain and a time domain;
encoding the signal based on a linear prediction process in the time domain, when it is determined that the linear prediction based coding is performed on the signal, in the switching structure between the plurality of coding domains; and
encoding the signal based on a transform process in the frequency domain, when it is determined that the psychoacoustic based coding is performed on the signal, in the switching structure between the plurality of coding domains,
wherein the signal has at least one of speech characteristic and audio characteristic.

2. A method of decoding an encoded signal, the method comprising:
checking whether a linear prediction based coding is performed or a psychoacoustic based coding is performed on the encoded signal, based on information included in a bitstream, in a switching structure between a plurality of decoding domains including a frequency domain and a time domain;
decoding the encoded signal based on a linear prediction process in the time domain, when it is checked that the linear prediction based coding is performed on the encoded signal, in the switching structure between the plurality of decoding domains; and
decoding the encoded signal based on at least an inverse transform process in the frequency domain, when it is checked that the psychoacoustic based coding is performed on the encoded signal, in the switching structure between the plurality of decoding domains,
wherein the encoded signal has at least one of speech characteristic and audio characteristic.
